(19) United States
(12) Patent Application Publication
(10) Pub. No.: US 2009/0090222 A1
(43) Pub. Date: Apr. 9, 2009

(54) Sink sprayer holder installer

(76) Inventor: Robert Jerome Schroeder, Maryland Heights, MO (US)

Correspondence Address: ROBERT JEROME SCHROEDER, 11951 AUTUMN TRACE COURT, MARYLAND HGTS, MO, 63043, US

(21) Appl. No.: 12/231,654

(22) Filed: Sep. 4, 2008

Related U.S. Application Data
(60) Provisional application No. 60/967,455, filed on Sep. 5, 2007.

(51) Int. Cl. B25B 13/02

(52) U.S. Cl. 81/119

(57) ABSTRACT

The Installer head notches carry a standard two or four winged nut. The control shaft has a pull ring in the very top and holes for a handle to be inserted as needed. The controller is pinned in support ring diameter, inverted up the cavity centered and cemented into the lower body diameter.

Place the wing nut in body head notches and drop the pull line through the holder shank. Hook and pull ring to pull the controller out the holder top. When the controller is pulled out the holder top the wing nut will be positioned to align with the shank threads. Insert the handle to prevent a all back into the cabinet. Lift handle turn the top holder clock wise by hand until wing nut is snug. Use the handle to turn the shaft counter clock wise for the final torque.

### BACKGROUND OF THE SPRAYER INSTALLER

In November 2006, I needed to replace a sprayer in a granite sink top, it had all the classic obstacles in the sink cabinet and the sink was 10 inches deep and close to the wall. I saw it as a high on the difficulty meter. All sprayer holder tools that I could find worked on the premises that they must be installed or removed from under the sink. The nozzle holder was placed in the corner behind the garbage disposer. Drawer runners were riveted to a steel floor. It was not visible. This was the most difficult job I had seen when doing a faucet installation. I was unable to find any new tools or operation that would simply this job. I read “How to books written by tool manufactures, Questioned Plumbing supply houses, read faucet manufactures installation information and discussed it with plumbers and handy men on the internet. The plumbers all said remove the plumbing and use a basin wrench. The supply houses said you would have to get under the sink and use a cylinder type basin wrench. The faucet manufactures recommended a jaw type basin wrench. This will work for removal but it is almost impossible to start the threads for installation.

I told my self that there must be a better way and started thinking about “How to change and improve this removal and installation job”. My first thought was it would be best if I could complete the work from the top of the sink. I hit on the idea to hot glue a ⅜” extension shaft rod to a 30 mm shallow drive socket and use a string to pulled it in place and use a ratchet to remove the fastening hex nut. This worked because the counter top only left an inch or for the shank to protrude out the bottom and the threads of the shank nut to be unfastened, it was more difficult to reinstall because the nut was resting on the bottom of the socket and I could not start the threading because the shank was too short to reach it. I used plumbers putty to make the hex nut stick at the top of the socket, I practiced is method in my garage with two saw horses and board with a one inch hole in it. I developed the feel of working blind. Once I felt comfortable with the make shift tool I removed the old holder so I could install the new one. That's when I decided to build a tool that will work on different size holders and shanks.

### THE SUMMARY

The sink sprayer holder location can make the sink sprayer holder installation a very difficult job. It is normally placed in sink top in between sink bowl and cabinet wall. The holder top flange will set on the sink or counter top. The holder shank extends through sink top in to sink cabinet. The fastener location can be bidden behind a deep sink, water feed lines, waist drain lines and the garbage disposer. These are hassles that are associated with the holder installation.

The hook line is used to pull wing the body up to the holder shank and control shaft out the holder top. The handle installed to lift the wing nut into shank threads will position the wing nut and the holder shank to align for threading. Hold the shaft steady and turn the holder clock wise to snug the fastener. Use handle and turn it counter clock wise to finish the torque. All important variables are controlled above the counter top.

Tools recommended by Faucet Manufactures and Plumbing Help Manuals are classed as basin wrenches. The USPTO has list of patents in this category. All tools that can be used for this operation are in this class but require the person doing the job to be under the sink to reach the fastener. The Sprayer Manufacture Installations Instructions and Help Books show the installations being made in a free standing sink or a cameo picture. Most often the jaw type with a telescoping handle the tube with notches or channel lock are recommended for the job. This job is not complicated because all it consists of is screwing a wing nut on a holder shank. But if you are working under the counter with tools in a sink cabinet it can be difficult. The sink sprayer is designed specifically to install the holder and fastener using the above the counter procedure with the inverted shaft and the pull ring and hook line. The other under the counter tools do not address using top down approach or provide additional hardware for the operation.

### THE DESCRIPTION OF THE HOLDER INSTALLER

The sink spray holder installer was designed for installing and removing sink sprayer holder. It has a main PVC cylinder body that has four notches evenly spaced in the top rim to carry wing nut. The control shaft is smaller diameter structural metal and is pinned in to the center diameter of a support ring. It is centered and inverted up the body cavity of the main body is used for elevation and control. It will extend out above holder to the when the controls shaft is used to pull wing nut up to shank threads. It has three sets of thru holes pre drilled for the steel wrist pin, the portable pin handle and the pull ring. A fabricated pull line is used to hook the pull the ring out of the holder top to install the portable handle to avoid a fall back.

The spray holder is simple and uses a top of the counter procedure to complete the operations necessary for a new installation or removal of a holder. This method eliminates hassles caused by being on your back reaching up and trying to start the wing nut using the older methods for installation and removable of a sprayer holder

Start the installation by placing the spray holder shank in the counter top and the wing nut in the body head notches. Place it in the sink cabinet convenient to the holder shank location. Drop the hook line down holder let the stopper rest on the holder top. Use this to elevate and pull the wing nut up to the shank threads when the control shaft is pulled out holder top. This will position the holder shank to align with wing nut threads. Install the pin handle in the control shaft so it will not fall back in the sink cabinet. Lift the shaft handle to raise the holder enough to start turning the holder counter clock wise continue holding holder steady until the wing nut is sung. Finish the torque by turning the handle counter clock wise.

The removal procedure; Drop the hook line in holder shank and attach the hook to the control shaft in the sink cabinet. Use pull line hooked the control shaft to pull the controller the out the holder top and install the handle pin. Lift the handle with turning motion until you feel a resistance, feel a slight elevation or hear click when the wing nut merges with the head notches with the wing nut. Start turning the handle clock wise to start to remove removal of the wing nut.

1. This Application claims the benefit of the U.S. Provisional Patent APPL No. 60/967,455 Filed Sep. 5, 2007 Title: Sink sprayer holder installer.

2. The control shaft is pulled up and through holder top positioning the wing nut to align with the shank threads. The wing nut pushed against the shank threads and will lift the holder top to align the holder for threading the wing nut. Steady the shaft and turn the holder clock wise to start threading wing nut and shaft threads. The body cavity will hold the threaded shank.

3. The tool model was built to install the wing nut. But I do currently have a head that will install or remove a hex nut. The sprayer holder installer can be developed to use new heads that can benefit from the above the counter installation and removal of the holder fastener.
